(19) United States
(12) Patent Application Publication
(10) Pub. No.: US 2014/0242565 A1
(43) Pub. Date: Aug. 28, 2014

(54) QUALITY MANAGEMENT SYSTEM AND PROBLEM SOLVING LEARNING ENVIRONMENTS AND DESIGN FOR 21st CENTURY SKILLS

(71) Applicant: Leigh Roy ABTS, Phoenix, MD (US)

(72) Inventor: Leigh Roy ABTS, Phoenix, MD (US)

(21) Appl. No.: 14/190,073

(22) Filed: Feb. 25, 2014

Related U.S. Application Data
(60) Provisional application No. 61/769,309, filed on Feb. 26, 2013.

(51) Int. Cl. G09B 3/06

(52) U.S. Cl. CPC G09B 3/06
USPC 434/350

(57) ABSTRACT

A system for managing course content for a course includes a database configured to store course content. Course content includes problem-solving learning environments and design (PSLED) blocks. An interface is configured to provide information from a PSLED block for a student. An input and output module are configured to receive and send input regarding at least one of the PSLED blocks stored in the database. An evaluation module is configured to evaluate the student based on assessment requirements in at least one of the PSLED blocks stored in the database and based on the assessment data. A mapping module is configured for analyzing and mapping attributes between PSLED blocks stored in the database, the attributes including at least one of equivalency of instructional units, equivalency of standards of learning and practice, equivalency of micro-certificates, and equivalency of micro-credentials.

### PRIORITY

This application claims priority to U.S. Provisional Application No. 61/769,309 filed Feb. 26, 2013, the contents of which is hereby incorporated in its entirety.

### FIELD

One embodiment is directed to a learning management system. More particularly, one embodiment is directed to a system of organizing and using structured learning units.

### BACKGROUND INFORMATION

A typical learning environment may separate coursework by subject and group topics within each subject together in a logical way. For example, a subject called “Algebra I” may introduce algebraic concepts and provide for instruction and evaluation of students taking the class. “Algebra II” may cover the same topics as foundational knowledge but provide more difficult problems and more intricate problems to build and develop new concepts for students to master in the field of algebraic mathematics. The class may present word problems for the student to solve by determining the physical relationships among fact elements and some unknown elements. Such word problems may represent a real world scenario from which to extract facts, but are word problems, not hands on problems

The topics covered in an Algebra class may involve math concepts such as functions, linear equations, polynomials, and graphic concepts involving slopes and curves. In order to teach students a subject in the traditional course/topic model in this example, instructors will typically provide students with the mathematic instruction covering the topic and discuss practice problems with the students. The students will typically then continue to practice the concepts through homework that may be evaluated for progress. Eventually the student will be evaluated for knowledge by broad based testing for each chapter or semester of material. At the end of the course, the student will have either passed or failed the course and will typically receive some sort of percentage grade that is supposed to reflect the students' mastery over the course material.

One issue with the traditional learning model is that it does little to provide students with actual real world skills. Because the emphasis is on learning course content, students generally do not achieve from a course the ability to apply the course content in a non-academic or cross-disciplined setting. Indeed, often no heed is given at all to applying the underlying processes to demonstrate through a project based exercise. Another issue with the traditional learning model is that the course grade does not offer any indication of the mastery of the students with respect to real world, practical applications that can be found in the workplace. Yet another issue with the traditional learning model is that it is not easily adapted to provide students with aptitude in a particular area to steer particularized learning experience based on needed skills so that some students may unnecessarily repeat coursework in which proficiency has already been attained. Another issue with the traditional learning model is that there is not always alignment between topics targeted and those actually covered in a course. Indeed, even though some learning models have recently evolved to focus on “common core” topics, there will inevitably be course topics that are covered outside of the “common core” or topics in the “common core” that are not covered in a particular course. Thus, disconnection can exist between two of the same classes in two different environments with no ability to capture the differences. As a student moves from one class to the next, discrepancies in pre-requisite knowledge and skills can be exacerbated detrimentally to the student. Another issue with the traditional learning model is that there is no support for “flipped” learning, where students self-learn at home and come to class to work problems. Flipped learning environments lack uniformity of teaching and evaluation standards. Another issue with the traditional learning model is that students do not benefit from having peer mentors or mentors other than their teachers or instructors.

### SUMMARY

Embodiments manage course content for a course including a database configured to store course content. Embodiments include problem-solving learning environments and design (PSLED) blocks, each one based on at least one of curriculum, instruction, skills, and assessment information. An interface is configured to provide information from a PSLED block for a student and configured to receive assessment data from a user. An input is configured to receive input regarding at least one of the PSLED blocks stored in the database. An output module is configured to send output regarding at least one of the PSLED blocks stored in the database. An evaluation module is configured to evaluate the student based on assessment requirements in at least one of the PSLED blocks stored in the database and based on the assessment data. Finally, a mapping module is configured for analyzing and mapping attributes between PSLED blocks stored in the database, the attributes including at least one of equivalency of instructional units, equivalency of standards of learning and practice, equivalency of micro-certificates, and equivalency of micro-credentials.

### BRIEF DESCRIPTION OF THE DRAWINGS

FIG. 1 shows an illustration of a Quality Management System (“QMS”) demonstrating a chain of reasoning between problem-solving learning environments and design blocks (“PSLEDs”), skills, disciplines, and certificates, in accordance with some embodiments.

FIG. 2 illustrates a system diagram for a QMS in accordance with some embodiments.

FIG. 3 is a flow diagram that illustrates how Evidence Centered Design (“ECD”), Understanding by Design (“UbD”), and Universal Design by Learning (“UDL”) can be used to develop PSLEDs, in accordance with some embodiments.

FIG. 4 illustrates how the QMS can align PSLEDs across critical thinking, argumentative writing, communications, cross-disciplinary thinking as well as project (time) management, and other important 21st century constructs, such a teamwork, collaborative learning and modeling, in accordance with some embodiments.

FIG. 5 illustrates how the QMS can create and align PSLEDs relating to Energy disciplines, in accordance with some embodiments.

FIG. 6 illustrates how a structured, reproducible and ‘auditable’ QMS system, such as QMS 100, creates PSLEDs, in accordance with some embodiments

### DETAILED DESCRIPTION

Recent studies on students (any learner) and learning systems have argued that learning should focus on skills over academics. In particular, researchers argue that students need to gain and practice “21st century skills” and that the workforce needs to develop and maintain “21st century skills.” These so-called 21st century skills can involve skills that include learning and innovation skills, 21st century themes, life and career skills, and the like. Example learning and innovation skills can involve skills including critical thinking and problem solving, creativity and innovation, communication and collaboration, scientific and numerical literacy, cross-disciplinary thinking, basic literacy, and the like. Example 21st century themes can involve issues surrounding global awareness; financial, economic, business, and entrepreneurial literacy; civic literacy; health literacy; environmental literacy, and the like. Example life and career skills can include flexibility and adaptability, initiative and self-direction, social and cross-cultural skills, productivity and accountability; leadership and responsibility, and the like.

Some in the field have developed certain learning frameworks and standards around the concept of aligning a range of 21st century skills to particular subject areas. For example “Common Core,” “Common Core Standards of Mathematics Practice,” and “Next Generation Science Standards” all include consideration for aligning subject material with 21st century skills.

Government is also involved in the discussion of aligning 21st century skills to learning platforms. For example, the U.S. Department of Education set forth the expectations of the educational system (federal, state, districts and schools) by outlining benchmarks to prepare and assess students to be college and career ready. These benchmarks include: rigorous college and career-ready standards; rigorous and fair accountability and support at every level; measuring and supporting schools, districts, and states; building capacity for support at every level; and assessing achievement.

No clear and consistent system exists, however, that addresses the issues involved with aligning 21st century skills to course content. There are no known system to create and map auditable chains of reasoning to link students' and practitioners' depth of understandings and practices, to assessments within across the broad range of 21st century skills to cover the range of procedural, cognitive, behavioral, and attitudinal constructs required to track and evaluate trajectories of learning and achievements (individual and cohorts) related to college, career, and workforce readiness. In other words, there is no known end-to-end solution for addressing and linking academic knowledge to applied skills like the one presented below. One example where this is relevant is when linking and applying knowledge and skills across content and disciplines, and then assessing how a student applies skills in these cross-discipline settings, and how they can eventually apply skills in a real life workforce setting.

A quality management system (QMS) provides an integration and measurement system for tying specific educational content, experiential activities, and individuals' learning and assessment to workforce and academic 21st century skills certifications and credentials of all kinds. The QMS model is flexible but powerful for providing an avenue of organizing and aligning educational content.

The QMS model divides educational content and experiences into problem-solving learning environments and design blocks (“PSLEDs” or “PSLED blocks”). Each PSLED block can represent a unit of student curriculum or instruction, a 21st century based skills, or an assessment track, in addition to any other educational minutia. PSLEDs provide the logical base from which a QMS can create the chains of reasoning and auditable links between a student and teacher or employee and instructor. The terms PSLEDs or PSLED blocks are used interchangeably throughout.

PSLED blocks can be assembled into specific lesson plans, experiential activities, course units, courses, course equivalents, professional development and worker training curricula, and apprenticeships. PSLEDs and clusters of PSLEDs can become the foundation for processes that map ‘equivalency’ of learning and assessment to job related experiences and academic credit across: 1) courses in different disciplines; 2) learning communities; 2) modalities of instruction; 3) certification and credentialing programs; 4) modalities of training and professional development; 5) modalities of distribution, e.g., online, textbooks, media; and 6) development platforms.

For example, a student can be assessed to have the knowledge, prior training experience, and critical thinking skills associated with a desired 21st century skill. The assessment can come through other PSLED based processes in the QMS, such as a class that was previously completed. The student can receive credit for having completed a PSLED or clusters of PSLEDs relating to the particular 21st century skill. The student can take that credit and apply it to satisfy a portion of another class, demonstrate a prerequisite, or achieve a certificate or credential. The assessment could also come from an educational source outside the QMS, such as another classroom, self-study, an extracurricular activity, workforce training, or other life experience. The QMS can provide an assessment mechanism for a particular PSLED to these external education sources to determine whether the requisite knowledge, prior training experience, and critical thinking skills were achieved.

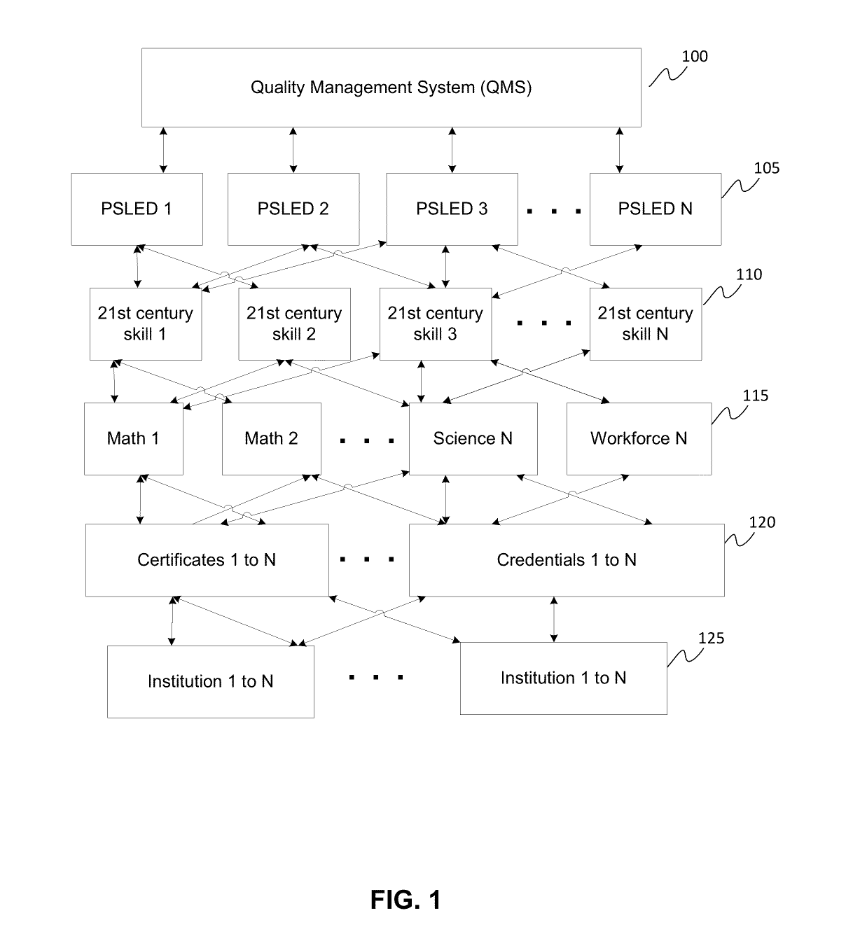

FIG. 1 shows an illustration of a QMS demonstrating a chain of reasoning between PSLEDs, skills, disciplines, and certificates, in accordance with some embodiments. QMS 100 controls and organizes each of PSLED 1, PSLED 2, PSLED 3, and PSLED N, at row 105. Each of the PSLEDs in row 105 is linked to one or more 21st century skills, at row 110. Each of the 21st century skills in row 110 is linked to one or more disciplines, subjects, or workforce topics, at row 115. Each of the disciplines, subjects, or workforce topics in row 115 is linked to one or more certificates or credentials, at row 120. Each of the one or more certificates or credentials in row 120 is linked to one or more institutions or employers, at row 125. The links between each row in FIG. 1 are bi-directional so that QMS 100 can be used to develop, maintain, audit, and analyze PSLEDs by following the links from one row to another, either up or down.

The courses in a field or discipline with embedded learning goals for students to develop and practice 21st century skills can be through PSLEDs developed and organized from the QMS system. PSLEDS can be aligned to specific or multiple 21st century skills. As the chains of reasoning and auditability form between the PSLEDS and their mappings to 21st century skills, classifications for PSLEDs will overlay onto various courses and workforce training programs. As such, these classifications can lead to PSLEDS that become the prerequisites for other PSLEDs. Individuals will be able to gain certificates that demonstrate their proficiencies and competencies in a PSLED or clusters of PSLEDs. Individuals can include anyone receiving instruction, including students, teachers, instructors, workers, employees, and the like.

The chains illustrated in FIG. 1 can be viewed from multiple perspectives to help a course organizer, institutional trainer, certification authority, or other evaluator determine how to align PSLEDs to skills and can be followed up or down. For example, PSLEDs can be developed by starting at a subject, such as Math 1 found in row 115, identifying a set of skills associated with Math 1 from row 110, and organizing one or more skills into a PSLED in row 105. Other skills can be organized into other PSLEDs. Further abstraction can be achieved by starting at the institution level. For example, one could establish an institution for training plumbers; identify a set of needed certificates to demonstrate mastery in the field of plumbing, such as Heating, Ventilation, and Air Conditioning and drain installation at row 120; and then identify subjects or disciplines needed for each of the certificates.

A QMS such as QMS 100 has potential to be applied across, but not limited to:
k-12 and the alignment of curriculum, instruction and assessment to the Common Core (“CC”) and Next Generation Science Standards (“NGSS”);
grades 9-20 career and workforce training pathways including military training programs, and equivalency of these programs to academic or occupational training;
practitioner and professional development training programs and continued professional certifications for fields dependent upon critical 21st century skills, e.g. problem-solving or teamwork;
programs that prepare teachers, instructors and trainers of students, veterans, and trainees in 21st century Skills—e.g. career apprenticeship programs;
programs that certify and credential developers of PSLEDs;
GED and other equivalency programs;
professional development models for teachers or instructors and for a train the trainer model; and
both formative and summative assessments across the various PSLED blocks, thus enabling the longitudinal tracking of individual students and cohorts of students.

To produce PSLEDs, the QMS aligns three known educational models: Understanding by Design (UbD), Universal Design for Learning (UDL), and Evidence Centered Design (ECD). This is discussed in further detail below.

A PSLED block can be any element of curriculum, instruction, assessment, workforce training, experiential learning environment, design project, professional development, and the like. A PSLED block used by the QMS differs from traditional educational concepts in the way that it is developed (and in the way that it is maintained, discussed in further detail below). PSLED blocks can be combined into clusters that represent progressively more inclusive concepts. A cluster of PSLED blocks, for example, can make up the material covered on a particular class day. A cluster of clusters of PSLED blocks can make up the material covered in a syllabus for a particular topic, and a cluster of clusters of clusters of PSLED blocks can make up material covered for a block of topics, such as subjects across a course, subjects across courses, or material across a training program, such as an apprenticeship.

One way to understand clusters of PSLEDs is by analogy to a set of interlocking toy bricks, such as “Legos.” For example, the set of bricks can include red blue, and yellow bricks, each color corresponding respectively to curriculum, instruction, assessment PSLEDs. A particular skill can be built by taking PSLED bricks of different colors and building a shape of different colors that represents a skill in the context of a particular subject. Different shapes can be combined to demonstrate a skill in a cross-discipline, such a shape for math and a shape for biology. Other colored bricks, such as an orange brick can include PSLEDs that include both curriculum and assessment aspects (such as review material related to a skill). A single course could include an elaborate framework of interlocking bricks. Thus, one of skill in the art will recognize that the PSLED blocks can be combined as needed.

In some embodiments, a PSLED can be broken down into smaller and more discrete PSLEDs. Thus, a cluster of PSLEDs can also be referred to as a single PSLED, and it may be more convenient to treat a cluster of PSLEDs as a single PSLED for some purposes. Generally, when used herein, a PSLED can mean a single PSLED or a cluster of PSLEDs.

PSLED blocks can also be clustered to focus on certification or credentialing. For example, a cluster of PSLED blocks can be used to define a credential needed for calculating heat transfer characteristics leading to a design for a heat exchanger. PSLED blocks can also be clustered so that a student can have some flexibility in satisfying the requirements for a certificate.

PSLED blocks can be clustered to apply skills in cross disciplines. For example, referring again to FIG. 1, both Math 1 and Science N on row 115 require 21st Skill 3 in row 110. 21st Skill 3 can be demonstrated in both PSLED 2 and PSLED 3 in row 105. Thus, PSLED 2 and PSLED3 can be clustered to focus on 21st Skill 3. Students can learn 21st Skill 3, which may be a math skill, and learn how to apply it in a real world application in a science discipline. Real world applications include hands on problems where students gather, perhaps through research or experimentation, and analyze information through activities to solve problems. Real world skills include 21st century skills and knowledge, such as collaboration, innovation, team work, and creativity.

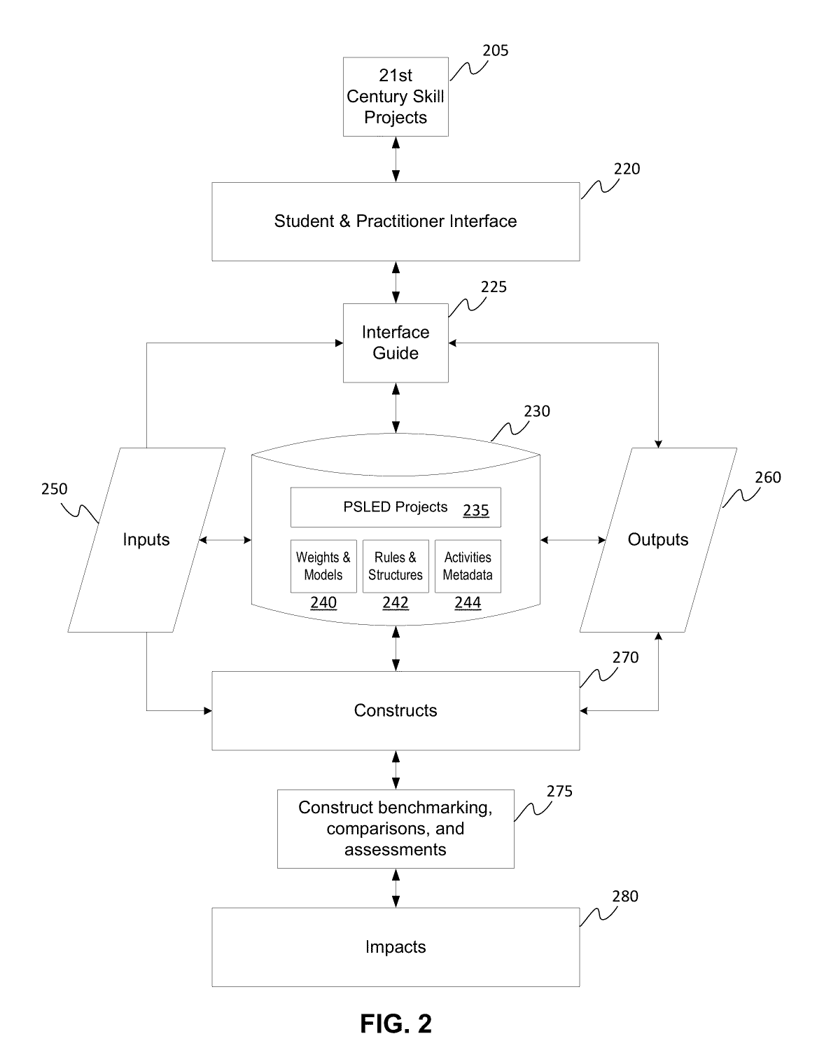

The QMS can organize and control PSLEDs in a computer implemented environment utilizing a database or e-portfolio of databases. FIG. 2 illustrates a system diagram for a QMS in accordance with some embodiments. A set of 21st century skill projects 205 can include student work, capstone projects, end of course projects, other course projects, challenges (projects that include problem solving and design within and across courses, and in the case of an e-portfolio, within and across classroom, work, and life experiences.), compositions, or practitioner work. Projects 205 can serve as an interaction input/output for students and also serve as a work input for evaluation purposes. Evaluations are a feedback tool for both the students or practitioners and instructors that can be incorporated into the PSLED or cluster of PSLEDs. Evaluations and can inform about whether the student or practitioner has gained the PSLED, and import student or practitioner work into the QMS through evaluation results. Teachers, instructors, mentors, peers, and supervisors can all be part of the evaluation process in an interactive, real-time or delayed process.

A student and practitioner interface 220 provides mechanisms for students and practitioners to interface with the QMS. For example, interface 220 can include text, graphics, audio, video, computer-aided design, surveys, and others. Interface 220 can be a customizable interface based on preferences of the student or practitioner, including layout and design, or based on the educational focus of the student or practitioner, such as interest in the selection of PSLEDs, clusters of PSLEDs, or a training program. Interface 220 can include an adaptive assessment process, adaptive feedback process, and adaptive way to facilitate interactions between students, teachers, peers, mentors, supervisors, parents, and others. Interface 220 can be facilitated by an electronic device such as a computer, tablet, or mobile device. An interface guide 225, can provide a learning environment to present the information to the students and practitioners. Interface guide 225 can include high-level conceptualizations of the organization of PSLED blocks, such as learning and teaching rubrics, as well as more practical considerations such as a visual course layout. Interface guide 225, can also include scoring keys and produce customized front-end experiences for users based on profiles of students and practitioners.

A QMS database 230 stores and manipulates PSLED related information based on information gathered. For example database 230 can store PSLED projects 235 that include activity information tied to PSLEDs. Processes associated with database 230 can manipulate PSLED activity information through analysis of the information, and provide and store feedback based on the analysis. The analysis can be done in real-time (e.g., as information is received by database 230), at intervals (e.g., nightly), or at milestones (e.g., course completion). Metadata associated with PSLED projects 235 can also be stored and used in real-time analysis, or archived for later analysis or data mining. The metadata can specify expected data fields for a PSLED project and can hold data for individual students and practitioners for each project and activity attempted. Metadata can also specify the mentors, peers, or others that the student has interacted with.

Weights and models such as those in 240 can be developed for each activity for the purpose of evaluating and assessing activity results. Weights and models 240 can also be used to provide variable weights for activities in the overall assessment process. Rules and structures such as those in 242 can be developed for each activity to provide a framework for the activity that is passed through interface guide 225 for presentation to students, practitioners, instructors, and mentors and is also passed through to a constructs phase for evaluation and assessment purposes. Metadata 244 associated with the activities can be used to store information about activities that is passed through interface guide 225 for presentation to students and practitioners or to a constructs phase for evaluation and assessment purposes. For example, metadata 244 can change from one PSLED version to another PSLED version. Metadata 244 can be compared from one version to the next for course refinement. Data mining techniques can be used on database 230 to authentically assess and diagnose 21st century knowledge, skills, and abilities across the areas of college, career, and workforce readiness, in areas such as teamwork skills, problem-solving skills; critical thinking skills; communication skills; and skills for the integration of science, technology, engineering, and mathematics. For example, data mining can be used to map out the next academic, training, or life skills that the student should develop, learn, or apply.

Inputs 250 include knowledge based inputs from teachers, faculty, mentors, and trainers with experience in various particular PSLEDs. Inputs 250 also can include other databases relating to PSLEDs. In some embodiments, QMS database 230 can be understood to represent the e-portfolio of PSLEDs for a particular user, with each user having its own interface, such as interface 220, where skills 210 are obtained. Inputs 250 can also include items from external data sources such as cloud-based sources, including test scores or transcripts originating from PSLED or non-PSLED based training curriculum. Data available by inputs 250 can be mined using data mining techniques to include in QMS database 230. Inputs 250 can also include interfaces for facilitators including teachers, instructors, mentors, peers, and supervisors to provide feedback for students and for case management including interacting with each other to support the mutual development and evaluation of the student. Such interfaces can provide for both real-time and delayed interactions among facilitators and students, individually and in groups.

Outputs 260 include the transfer of knowledge and data to students, parents, teachers, faculty, mentors, and trainers for evaluation and growth. In some embodiments, outputs 260 can also include data transferred to other portfolios PSLED databases. Outputs 260 can also include transfer of data to external data repositories, such as cloud-based storage areas. Outputs 260 can also include reporting diagnostic 21st century skills assessments or equivalent test scores to legacy systems. Outputs 260 can also include interfaces for facilitators including teachers, instructors, mentors, peers, and supervisors to provide feedback for students and for case management including interacting with each other to support the mutual development and evaluation of the student. Such interfaces can provide for both real-time and delayed interactions among facilitators and students, individually and in groups. Outputs 260 can include custom reporting, such as for resumes, presentations, and data analysis respective to peers, or other information to highlight a student's or group of students' work.

Data analysis can use constructs, such as constructs 270, to perform cross-sectional modeling and prediction of skill profiles. Skill profiles can be modeled relating to design, problem solving, Common Core Standards of Mathematics Practice, Next Generation Science Standards, career clusters, college readiness, career readiness, and workforce readiness. Constructs 270 can distinguish between cognitive, applied practice skills, and other diagnostic analysis. Attributes including problem solving, creativity, communications, and teamwork can be evaluated against different rubrics depending on the goal of the student. For example, such attributes can be evaluated as aligning to college readiness attributes. Other examples include career readiness and workforce readiness. At elementary education levels, such attributes can be evaluated as aligning to progression attributes for an age, grade level, or other classification of a student. At professional education levels, such attributes can be evaluated as aligning to managerial attributes (or subject-matter expert type attributes), working with and collaborating with others, and creative skills to innovatively solve a problem. Constructs 270 can take inputs from inputs 250 and deliver outputs to outputs 260.

Information from constructs 270 can be analyzed by using benchmarks, comparisons, and assessments at 275. Construct analysis 270 can feedback to constructs 270 to provide to outputs 260 or provide to QMS database 230. Benchmarks can be used to determine whether certain goals have been met through the QMS. Comparisons can be used to compare different students or compare different PSLEDs for one student. Such comparisons may include comparisons of the instruction that the students received, mentoring and mentors, and projects that have the same or similar PSLED maps to those of other students. Assessments can provide a check on the PSLEDs and QMS system to analyze the effectiveness of PSLEDs across samples of students, teachers, trainers, assessors, mentors, peers, parents, and programs.

Various impacts of these benchmarking, comparisons, and assessments analysis in 275 can be assessed at impacts 280. Examples of considerations in design impacted include: PSLED independent developers, project-based assessments, transferability of credit, college admissions, competitive awards, degrees, academic and workforce advancement, 21st century skill credentialing, 21st century skill certifications, institutional 21st century skill accreditation, tutoring programs, apprenticeships, and mentoring programs. Each of these may be impacted, for example, by constructs from the QMS system. Impacts can also encompass further data mining to assess information about the status of students, for example to provide profile information to colleges for admissions purposes, to analyze student's existing training and suggest additional for students, and to analyze available PSLEDs and create new PSLEDs based on skills. Impacts 280 can also include the analysis of prior workforce experience that can be aligned to a PSLED or cluster of PSLEDs so as to award credit for prior workforce related activities. For example, a skilled job such as HVAC technician or network engineer typically carry, not only on the job training, but hands on experience that can be parlayed into PSLED credit based on real world experiences. In particular, active duty or reserve military personnel may receive extensive training and more importantly extensive real life workplace experiences that can be quantified using PSLED blocks or clusters of PSLEDs to award credit to personnel.

Thus, a QMS, such as QMS 100, can serve to progressively research, develop, and test interfaces, functionality, and principled assessment strategies including reporting mechanisms. QMS and the application of specific models of PSLED development can enable the development of task sets and banks, sets of evidence identification and accumulation rules, reporting formats, as well as data-collection, management, and analysis protocols. One goal of the QMS system of FIG. 2 may be to quantify student 21st century knowledge, skills, and abilities within the context of a complex engineered system framed by Evidence Centered Design principles. The QMS system fully utilizes the ‘data and information’ students, practitioners, and others are submitting to the e-portfolio databases. By incorporating Evidence Centered Design, the QMS system can provide a methodologically framework to create pathways for data mining, psychometric, and diagnostic assessment methods along with design-based research around human interface construction, database management, reporting mechanisms, program development and implementation, selection of students, optimized training for teachers and instructors, and emerging cloud compliance.

The QMS system can use the framework of FIG. 2 and a processor to automatically assess PSLED activities by students and practitioners over interface 220 by processing PSLED projects 235 according to their weights and models 240, rules and structures 242, and activity metadata 244. Constructs 270 and benchmarking 275 can determine which PSLEDs have been satisfied and output at 260 credentials establishing proficiency in PSLEDs or clusters of PSLEDs. Automatic assessment can be done for both students or practitioners and teachers or instructors.

As described above, the QMS system can use the framework of FIG. 2 to track the accumulation of PSLEDs for individual students, practitioners, workforce, employees, and skilled workers (including military or former military members). These PSLEDs can be organized by topic, content, or practice area. In addition, the QMS system can develop unique certificates and credentials based on the achieved PSLEDs (described in further detail, below). In addition, the QMS can align certificates and credentials to existing PSLEDs to award PSLEDs to users based on already achieved certificates and credentials. The QMS system can compare achieved PSLEDs with other available PSLEDs and identify available PSLEDs (or build customized PSLEDs) to demonstrate other related competencies. The QMS system can identify new job skills associated with PSLEDs and suggest those PSLEDs or custom PSLEDs be earned to achieve a new job skill. Such new job skills can then lead to new job opportunities. One skilled in the art will understand that “PSLEDs” as used here also includes “clusters of PSLEDs”

The QMS system of FIG. 2 can address real gaps in known e-portfolio platforms that lack comprehensively engineered assessment strategies and standards. Contrary to known e-portfolio platforms, the QMS system can achieve comprehensively engineered assessment strategies and standards by 1) applying principled evidence-based assessment practices; 2) applying principled approaches (such as “Understanding by Design” approaches discussed in greater detail below) to align student's knowledge, skills, and abilities depths of understandings to specific and global task models; 3) applying principled approaches to create representations and expressions for each PSLED and cluster of PSLEDs to equitably engage the broadest diversity of students, and instructors (such as “Universal Design by Learning” approaches discussed in greater detail below); 4) position the e-portfolio for a variety of applications (e.g., Advance Placement (“AP”) Engineering Design for Engineers, AP Engineering Design for science, technology, engineering, and mathematics majors, undergraduate engineering students for “ABET accreditation”, student competitions, etc.); 5) combining and integrating common and generalizable psychometric and data mining tools to diagnostically assess 21st century knowledge, skills, and abilities; 6) assess knowledge, skills, and abilities to support student learning trajectories across college, career and workforce readiness; and 7) enable the synthesis of profiles of 21st century knowledge, skills, and abilities across commercial, open-source, and home grown e-portfolio variants.

Other embodiments of the QMS system can, using similar approaches as those discussed above and discussed in additional examples below, be implemented to achieve other benefits, such as one or more of the following:
establishing a ‘chain of reasoning’ between students' depth of understanding, the evidence that demonstrates their understandings, and the assessment tasks to quantify their understandings;
creating different representations of a ‘chain of reasoning’ to expand a PSLED for different learning styles and for different venues—Algebra I classroom versus online;
interconnecting and aligning the various modalities of assessment;
integrating and expanding the overall QMS system to any kind of learning;
creating individual PSLEDs and clusters of PSLEDs related to progressively learning a specific 21st century skill or clusters of skills;
establishing ‘chains of reasoning’ and practicing to establish equivalency of credit between PSLEDs, representations and expressions of PSLEDs, learning already acquired, and delivery PSLEDs through different venues;
establishing a system to develop and align PSLEDs across the curriculum not only for science, technology, engineering and mathematics (“STEM”), but also for subjects including English and the social sciences, e.g. stressing the design process;
allowing a flexibility of practice to align the units and PSLED to the most appropriate standards, and as standards change, the chain of reasoning and evidence to modify a PSLED to align to the new standard;
guiding the implementation of a PSLED over a wide range of venues, including flipped classrooms (classes that use a video (sometimes viewed at home) as the main instruction with in-class work based on the lecture), online courses, and blended learning;
providing a standard approach for independent developers to create PSLEDs and elements of PSLEDs;
providing a structured system to incorporate technology;
providing a standard methodology to create professional development processes tailored to different levels, e.g. teachers and trainers of trainers;
providing a system to train and certify independent developers of the units;
providing a model to create and align technologies to deliver the units, including the creation of apps for the iPhone, iPad, or other tablet or smartphone, or applications for a Microsoft platform;
allowing for a chain of reasoning to create tailored micro-credentials for professionals.
allowing for a chain of reasoning to create tailored micro-certificates for academic and workforce training programs;
defining a system to refine/redefine AP/College Boards programs and GED programs through the micro-credentials and micro-certificates;
providing compatibility with textbook supplements or on-line games for problem solving;
impacting online courses by creating PSLEDs and clusters of PSLEDs that are based on an established chain of reasoning for equivalency of credit;
providing a flexible system to include real-world problem solving examples across a range of disciplines, such as energy, engineering math, and additive manufacturing;
providing a methodology to align assessments for diagnostic purposes from the individual student to cohorts of students;
facilitating on-line or artificial intelligence based teaching tools;
diagnosing weaknesses in teacher backgrounds and allowing for their correction before a teacher uses a PSLED;
extending the use and application of e-portfolios;
structuring information into and out of an e-portfolio;
integrating with existing learning management systems, such as “Moodle” or “Blackboard”;
complementing and supplementing the “Carnegie Unit”; and
supplementing and enhancing high stakes tests, like the “SAT” and “ACT” tests.

In addition to managing and implementing PSLEDs, as discussed above with respect to FIG. 2, the QMS system, such as QMS 100, can be used to develop PSLEDs. PSLEDs can include of blocks of curriculum, instruction, assessment, or professional development. PSLEDs can be clustered together to produce unique and customized course offerings. As referenced above, the QMS system aligns three known educational models—Evidence Centered Design (“ECD”), Understanding by Design (“UbD”), and Universal Design by Learning (“UDL”)—which can be used to create and align the PSLEDs.

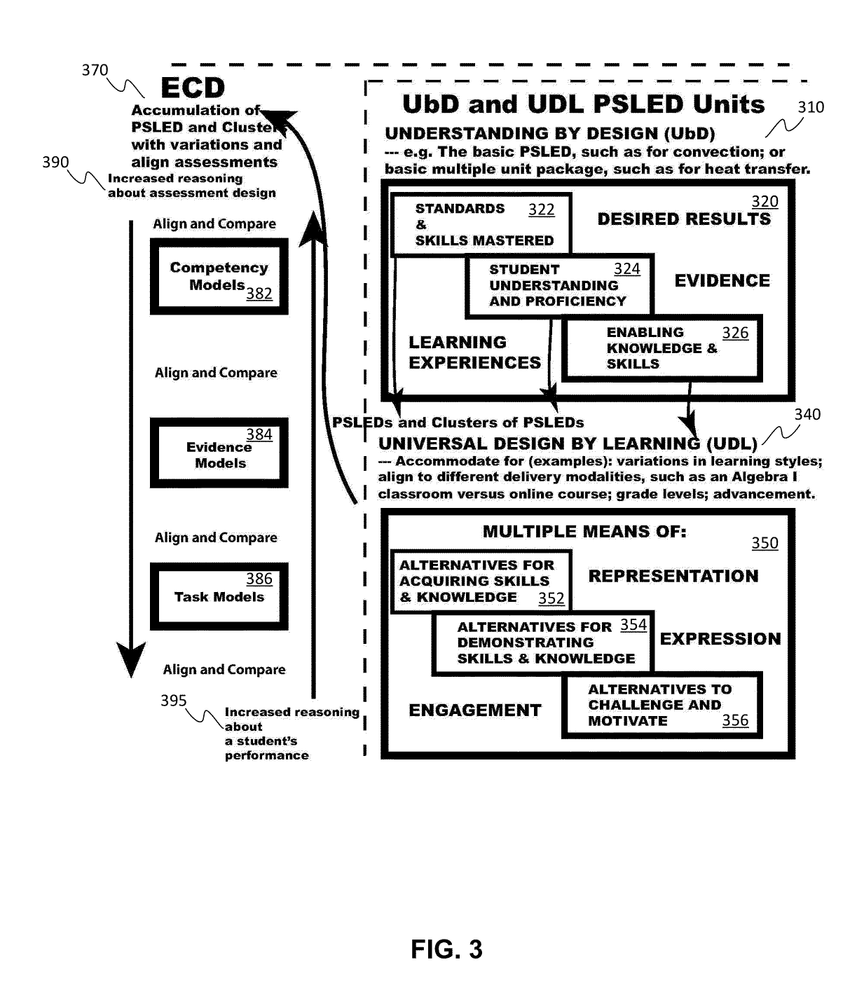

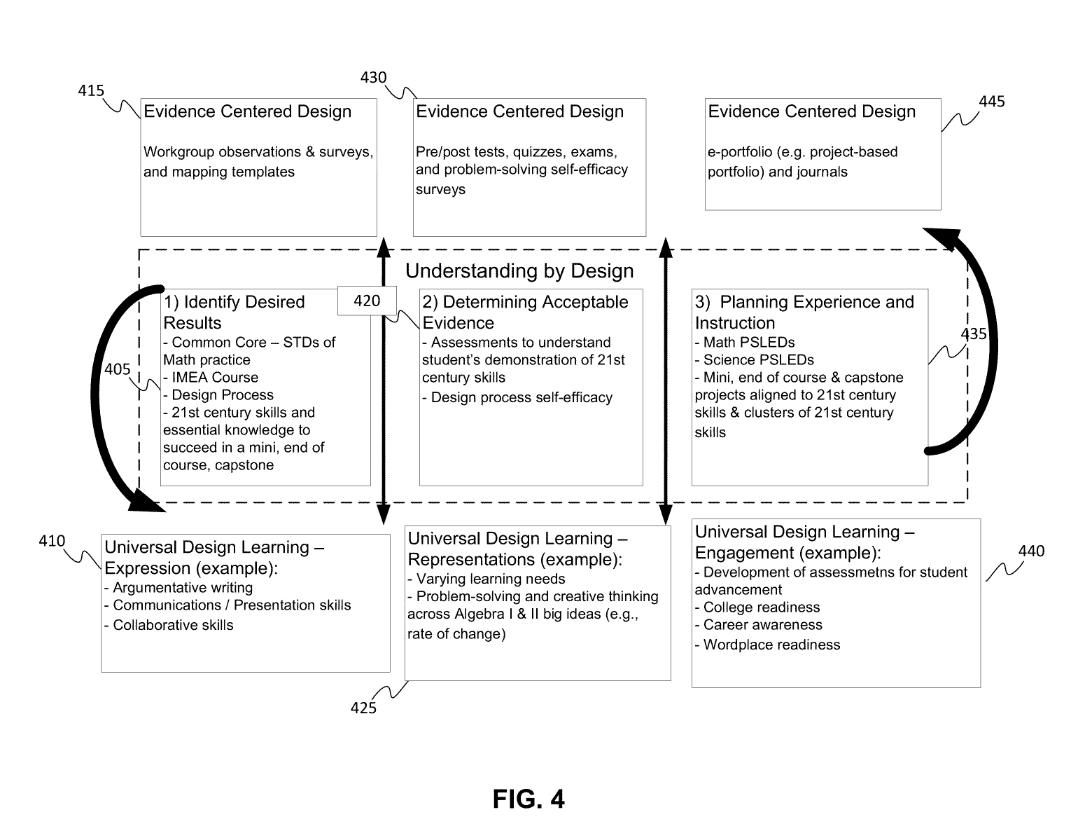

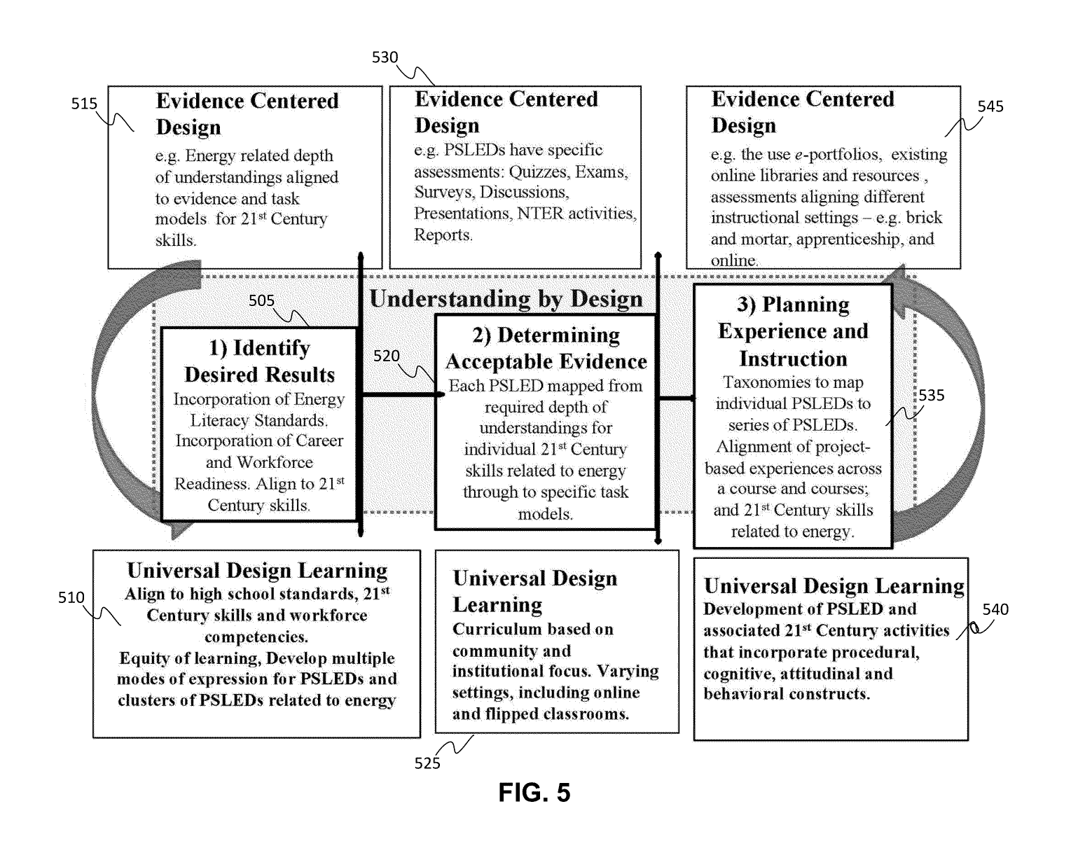

FIG. 3 is a flow diagram that illustrates how these three models, ECD, UbD, and UDL can be used to develop PSLEDs, in accordance with some embodiments. In some embodiments, the functionality of the flow diagram of FIG. 3 (as well as FIGS. 4-5), is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software. Although ECD, UbD, and UDL are specifically discussed below, one of ordinary skill in the art will understand that other educational models can be used in place of or in addition to these educational models to achieve similar results.

ECD provides the overarching thrust of organizing PSLEDs and clusters of PSLEDs to achieve chains of reasoning and alignment between skills and instruction. PSLED blocks are generally developed initially using UbD models, such as at 310. For example, a basic PSLED can address the concept of convection. A basic cluster of PSLEDs can combine the convection PSLED with other PSLEDs to address the concept of heat transfer. In UbD, at 320, desired results are identified, for example at 322, identifying standards and skills to be mastered at successful completion of the PSLED. Targeted evidence of the student's understanding and proficiency are determined at 324. These will set the benchmarks for evaluating a student. At 326, learning experiences are identified that can provide enabling knowledge and skills that can be later assessed. The basic PSLED can be augmented by a UDL design 340 to allow for variations in learning styles, variations in contextual forums (such as online versus in-class learning), variations in grade level, and variations in advancement or aptitude. At 350, multiple means of representation can be developed for alternative means for acquiring skills and knowledge, such as at 352. Multiple means of expression can be developed for alternative means for demonstrating skills and knowledge, such as at 354. Multiple means of engagement can be developed for alternative means to challenge and motivate, such as at 356.

Having gone through both UbD and UDL design, multiple PSLEDs could be created depending on the alternatives created by UDL 340, each representing the same topic or theme, for example convection. Thus, in order to provide a consistent PSLED result across all the alternatives ECD 370 is used to accumulate PSLEDs and clusters of PSLEDs with variations and align assessments amongst them (for each base PSLED or cluster of PSLEDs). At 382, uniform competency models are developed for each of the PSLEDs. The uniform competency models can be the same for each PSLED or cluster of PSLEDs, or the uniform competency models can be selected so that each achieves the same result. In other words, targeted student standards and skills for mastery at 322 of the basic PSLED can be aligned to have the same competency classifications for an alternative PSLED with variations in the alternative standards and skills mastered at 352. These competency models can be aligned and compared and administered through evaluation of the implemented PSLED to achieve a consistent and reliable result among different instances of instruction and evaluation of the PSLED at issue. For example, whereas a candidate for a job may be required to learn or demonstrate competency in multiplying together two three digit numbers, a third grade student may be required to learn or demonstrate competency in multiplying two numbers, each up to the value ten. In this example, these PSLEDs or clusters of PSLEDs can be considered equivalent for a basic premise, but simply variations of each other, but aligned to be equivalent based on the typed of alternatives developed at 340.

At 382, uniform evidence models are developed for each of the PSLEDs. The uniform evidence model can be the same for each PSLED or cluster of PSLEDs, or the uniform evidence model can be selected so that each achieves the same result. In other words, similar to the competency models above, student understanding and proficiency demonstrated at 324 of the basic PSLED can be aligned to have the same evidence classifications for an alternative PSLED with variations in alternatives for demonstrating the same skills and knowledge at 354. These evidence models can be aligned and compared and adjusted through self-evaluation of the PSLED to achieve a consistent and reliable result among different instances of instruction and evaluation of the PSLED at issue.

At 386, uniform task models are developed for each of the PSLEDs. The uniform task models can be the same for each PSLED or cluster of PSLEDs, or the uniform task models can be selected so that each achieves the same result. In other words, similar to the competency models and evidence models above, student learning experiences used at 326 of the basic PSLED can be aligned to have the same learning effect for an alternative PSLED with variations in alternatives for engaging in the same challenges and motivations at 356. These task models can be aligned and compared and adjusted through evaluation of the PSLED to achieve a consistent and reliable result among different instances of instruction and evaluation of the PSLED at issue.

At 390, as competency models are aligned to evidence models, and evidence models are aligned to task models through comparison, increased reasoning about the effectiveness of the assessment design can be achieved. In contrast at 395, as task models are aligned to evidence models, and evidence models are aligned to competency models, increased reasoning about a student's performance can be achieved. Thus, ECD builds the process (curriculum, instruction, and assessment) foundations of UbD and UDL to extend the chains of reasoning to a coherent (and auditable) assessment strategy, thereby establishing the links in the chain for reasoning to compare the learning, assessment, and ‘credit’ for 21st century Skills.

Using PSLED blocks or units or clusters of PSLED blocks as a basis for identifying achievable skills, individuals can earn certificates that demonstrate their proficiencies and competencies in a PSLED or clusters of PSLEDs.

In some embodiments, QMS 100 can provide a methodology and a principled approach to ‘cluster’ PSLEDs. These clusters can be organized to offer task focused learning within and across multiple courses for students to progressively study and practice complex and cognitively challenging problems. From an instructional perspective, clustered PSLEDs could be implemented to allow progressively more open-ended instruction for teachers or instructors and students or practitioners to achieve the following broad range of learning outcomes:
Social (e.g., cooperative teamwork, and behavioral, as acceptance of the consequences of failure);
Personal (e.g., gaining the self-efficacy to tackle a complex problem and be persistent);
Intellectual (e.g., habits of mind, development of casual, argumentative, and critical thinking skills); and
Appreciation (e.g., procedural approaches, such as the design process).

The QMS can be organized to intentionally cluster PSLEDs to target specific skill sets, e.g., heat transfer leading to a design for a heat exchanger. Students can then be evaluated and assessed on competencies related to pre-requisite skills and knowledge for a specific academic or workforce competency—such as for an HVAC technician. Students can earn micro-certifications from teachers that have micro-credentials in that cluster.

Teachers and instructors can earn credentials that demonstrate their proficiencies and competencies to teach certain PSLEDs. Mentors and peers can earn credentials or micro-credentials to perform mentorship or support for students. PSLEDs can be developed specifically for this purpose, or a base PSLED can be varied to include additional measures that would indicate a teacher's proficiency to teach the targeted PSLED. Thus QMS 100 can be used to create professional development models for teachers or instructors and for a train the trainer model. Instructors or teachers may not be able to teach a class without first having been credentialed in the class content as well as further optional class teaching credentials. QMS 100 can align both formative and summative assessments across the various units, thus enabling the longitudinal tracking of individual students and cohorts of students.

Various PSLEDs might converge into a model to ‘cluster’ PSLED by specific learning activities, such as the energy concepts of conduction, convection, and radiation (e.g., related to heat transfer) for students and veterans. A separate cluster might be created for teacher professional development related to the instruction of a given cluster and in context of design, scientific method, and problem solving.

In some embodiments, from a professional development perspective, middle, high school teachers, community college faculty, and online instructors can be trained to gain specific credentials based on demonstrated core PSLEDs and or series of PSLEDs and clusters of PSLEDs, e.g., in context of Algebra I or II, Pre-Calculus, Career Cluster for Energy Generation Technician, or Automation and Production Technology. In addition, a specific teacher (or instructor) centric core PSLED, such as a Design and Scientific Inquiry can be offered to build teacher or instructor skills to provide foundational knowledge in certain domains, e.g., design.

Cost-effective professional development models can be created using QMS 100, such as webinars, and online courses to support a distributed geographical, training model. Professional development may be organized as workshops through partnerships with local institutions, such as colleges. Upon completion, participants can then be given online access to the units and all elements for their classrooms.

In some embodiments, students lacking a specific PSLEDs or a cluster of PSLEDs can demonstrate achievement (e.g. proficiencies and competencies) rather than repeat an entire course. Students lacking particular PSLEDs as prerequisites can acquire them by a variety of means (such as in an online marketplace, other learning institutions, homeschooling, or self-study) before taking that portion of the course that requires them. Less time and credit can be lost by transfer students or students who have done non-Advanced Placement (“AP”) advanced work in high school if their prior units of study or courses that ordinarily would not transfer now are based on PSLEDs. Thus allowing the new institution to award advancement and credit for PSLEDs already achieved at the necessary levels or variations from other institutions. Similarly, if the PSLEDs needed for certification for two related trades overlap, a worker can get two certifications without repeating the overlapping materials.

Similarly, PSLEDs can serve as a mechanism to easily facilitate the transfer between institutions. For example, the growing online industry is continually challenged by ‘transferability’ of credit. Students and professionals are not confined to one source of instruction or training. Enrollment is mobile and can move from a local physical classroom to a global web site. Mobile students may desire a diversified education, however, students may find that mobility can be constrained by the ability to transfer credit.

QMS 100 provides a system to map equivalency between PSLEDs, clusters of PSLEDs, courses with PSLEDs, and different modalities of learning and delivery. In some embodiments, the equivalency of instructional units (e.g., cluster of PSLEDs on a given topic, heat transfer) can be mapped. Some embodiments can map the equivalency of the entire course (e.g., an Algebra I course with embedded PSLEDs offered in a high school versus community college classroom versus online). In some embodiments, the equivalency of various standards of learning and practice can be mapped within and across PSLEDs. In some embodiments, the equivalency of micro-certificates earned by students based on a progression of PSLEDs clusters can be mapped. Some embodiments can map the equivalency of micro-credentials earned by teachers/instructors/trainers based on PSLEDs and PSLED clusters. Some embodiments of QMS 100 can map the equivalency of certifications/credentials for independent developers—e.g., like CISCO academy model—to create and publish PSLEDs.

QMS model 100 can facilitate transfer by the creation of equivalency maps by aligning the inputs and outputs from UbD, UDL and ECD, consistent with the system described in conjunction with FIG. 2 at 270. Equivalency maps can be created based on standards (e.g., Energy Literacy, Science and Occupational Competencies); big ideas (e.g., topics such as heat transfer); essential knowledge and learning objectives (e.g., Energy Career Cluster skills and knowledge); evidence of understandings (e.g., how the students are assessed to demonstrate competencies); and occupational maps (e.g., “DACUM's” occupational analysis for Wind Technicians). QMS model 100 can further facilitate transfer by assessments that cover the range of constructs important to problem solving, e.g., procedural, cognitive, behavioral, and attitudinal.

In some embodiments, QMS 100 can create the fundamental chains of reasoning and chains of assessments for alignment of PSLEDs, and clusters to create micro-certificates for students; to create micro-credentials for teachers, instructors, parents, mentors, or peers; to encourage developers to ‘produce’ PSLEDs that can be compared and packaged to meet the needs of different learning community; and to integrate new emerging technologies and online resources (e.g., through UDL).

In some embodiments, QMS 100 can enable and encourage independent developers to become certified to develop and align PSLED to curriculum, instruction, and assessment. Developers of PSLEDs can sell PSLEDs or clusters of PSLEDs in a marketplace. A rapid expansion of online resources has occurred for problem solving, e.g., lesson plans, experiential activities, assessment rubrics, and professional development. However, other than being aligned to a Common Core Standards of Mathematics Practice, emerging guidelines, like Next Generation Science Standards, or a workforce training process, these available resources do not address how the published or online resource can be effectively and systematically ‘stringed together’ to create a combined learning experience (e.g., problem solving scenarios) that students need to gain a wide breadth of knowledge, skills, and personal attributes. This wide breadth of knowledge, skills, and personal attributes are needed to be able to rationalize, solve, and develop possible solutions to move from basic to more complex problems which engage different cognitive processes. In addition, known solutions lack metrics to track performance in solving a basic problem that can be used to predict the quality of solutions for more complex problems.

As discussed, QMS 100 incorporates a structured system for developers to create and cluster PSLEDs (much like a developer would create and launch a new “iPhone” App). At the same time, QMS 100 can provide a system to study problem solving, and to create data that can be compared within and across implementation of PSLEDs, student's trajectories of learning, and the professional development of the instructors. As these activities increase, credentialing processes can allow for developers to follow and execute the QMS methodology, such as that in QMS 100.

As a result, existing resources such as those offered by organizations and companies like “Design STEM” illustrate how Understanding by Design can guide the development of individual units, each aligned to appropriate standards, and presented in a manner that engage students. However, the units are offered in isolation, much like a word problem, and the ‘insertion’ into the curriculum is left to the teacher or the school administrator.

Basing the “Design STEM” units on standards is only one step on the way to the ‘equivalency’ chains of reasoning required to compare units across not only standards, but also learning styles, cognitive reasoning and even communities of learning. QMS system 100 can address all the critical points of comparison to create the unbroken chain to compare units that is standards based, but also allows for the other aspects of problem solving to be assessed.

There are also other online resources that connect units by subject area. Most can be considered ‘isolated’ units offered in context of a given course, problem solving situation, or context. Other than standards, there are often no other comparative points.

In some embodiments, QMS 100 can guide the development of classifications or other instructional and professional development road maps for teachers or instructors to convert existing available online resources into resources that are aligned, not only to standards, but also to other procedural (e.g. the design process), cognitive, behavioral and attitudinal constructs critical for the broad implementation of PSLED(s). For example, an online course for active duty military members can be mapped or converted to a course based on PSLEDs, which can allow for an active duty military student to cover and achieve PSLEDs in person on base or remotely while deployed without suffering disconnection between in-person and online learning in the course. One result might be a business model or marketplace where such existing items can be converted or new items created to take advantage of the QMS system. These could be accomplished through an online interface, such as a web page or a smartphone app that can provide content to a user. In some embodiments, a PSLED can be developed by an independent source, such as through “Design STEM” or “Teach Engineering” and then redistributed as a PSLED. Royalties can be paid to the developer when sold as an individual PSLED or as a part of a cluster of PSLEDs.

In some embodiments, a ‘buyer’ could select from a menu of available PSLEDs to construct a course or a certificate pathway that aligned the block nature of PSLEDs into an ‘academic’ process. An online venue could price the package, and automatically generate an appropriate ‘academic’ credit, micro-certificate, or micro-credential that the buyer's selected menu of PSLED blocks selected would equate upon completion. The opportunity for ‘customization’ of clusters of PSLEDs can present a new market for education or training focused on achieving PSLEDs rather than full courses, resulting perhaps in greater flexibility and retention for some students. In some embodiments, the ‘buyer’ can be a student and the marketplace a learning institution, where the student can choose PSLEDs to develop their own curriculum and courses. Degrees or diplomas can be awarded by the institution based on micro-credentials or micro-certificates addressing different clusters of PSLEDs. In other embodiments, the ‘buyer’ can be a learning institution that selects packaged PSLEDs to develop courses for its students.

Certain courses are curricular anchors for both for mapping of prerequisites and for mapping of introductory undergraduate courses, such as those for Advanced Placement. A QMS system, such as QMS 100, along with its PSLEDs can create a new system to develop an AP Curriculum and high stakes tests. Thus, students can gain certifications for specific 21st century skills and sets of 21st century skills by completing PSLEDs as an alternative method for individuals to gain advancement and transfer credit.

Standardized tests for college admissions, such as SAT and ACT can be supplemented or augmented by inclusion of PSLED assessments and PSLED based certificates that demonstrate an individual's proficiencies and competencies in individual and sets of 21st century skills.

The chains of reasoning and mapping of 21st century skills to procedural, cognitive, behavioral and attitudinal constructs can be used by professional examinations and credentialing processes to evaluate broader ranges of occupational skills and knowledge sets, in some embodiments.

Although usage of the QMS has been described above and its versatility illustrated by example, the following examples provides a more specific illustration of how the QMS can be implemented, in accordance with some embodiments. In this first detailed example, PSLEDs aligned to pre-college and workforce 21st century skill development curriculum, instruction, and training to meet the Common Core (“CC”), Common Core Standards of Mathematics (“CCSMP”), and Next Generation Science Standards (“NGSS”) with the intent to apply QMS for all students to be college and workforce ready with assessable 21st century skills.

The basic premise for this QMS field of use example is that the design process is a structured, and widely practiced methodology to not only solve problems (e.g., by engineers, architects, fashion designers, etc.) but also develop and practice many of the critical 21st century skills cited in the reports. Design as a structured problem-solving, critical thinking, and innovation process can engage students in the learning and practice the broad range of 21st century skills cited for academic and workforce readiness.

FIG. 4 illustrates how the QMS can align PSLEDs across critical thinking, argumentative writing, communications, cross-disciplinary thinking as well as project (time) management, and other important 21st century constructs, such a teamwork, collaborative learning and modeling, in accordance with some embodiments. This QMS example ‘back maps’ a college Engineering Mathematics 100 course—Introductory Mathematics for Engineering Applications (“IMEA”)—to a mathematics and science curriculum for a high school. The PSLEDs developed based on the IMEA course are mapped within and across disciplines that include Algebra I, Algebra II, Geometry, and Pre-Calculus. The IMEA class has a broad range of real world applications that are suitable to use for the PSLEDs goal of tying skills to real world learning opportunities and learning settings.

IMEA emphasizes problem-solving learning environments anchored to the mathematics from across the undergraduate engineering curriculum. The course's main content areas include: Basic Algebraic Manipulations; Trigonometry, 2-D vectors; Complex numbers; 3-D Vectors and Matrices; Sinusoids (Amplitude, Frequency, and Phase); Basics of Differentiation; Basics of Integration; and Linear Differential Equations with Constant Coefficients. An end of course project stresses the importance of applying design as an iterative problem solving process that often results in failure. Students learn and practice the range of critical 21st century skills to develop, refine and to test solution pathways—skills ranging from problem solving, innovation, teamwork and communication, time management, and many other of the range of skills cited for college and career readiness.

At 405, consistent with the flow diagram of FIG. 3, UbD is used to identify desired results. In this case, such results include Common Core standards of Math Practice, IMEA course material, design process, 21st century skills, and essential knowledge to succeed in an end-of-course test. At 410, UDL is used to identify alternative skills and knowledge, including for example, argumentative writing, communications and presentation skills, and collaborative skills. At 415, the standards and skills in 405 and 410 are aligned through ECD to produce workgroup observations, the potential use of e-portfolios, surveys, and mapping templates. At 420, UbD is used to identify evidence of learning, including assessments to understand student's demonstration of 21st century skills, and design process self-efficacy. At 425, UDL is used to identify alternative forms of evidence, including varying learning needs for cross-disciplines like problem-solving and creative thinking across Algebra I & II and broader concepts or big ideas such as the cross-discipline concept of “rate of change.” At 430, ECD aligned the results of 420 and 425 by providing pre-tests, post-tests, quizzes, review of portfolios, and exams as well as self-efficacy surveys.

At 435, UbD is used to identify learning experiences and instruction, such as creating or using existing Math PSLEDs, Science PSLEDs, and mini, end-of-course, capstone projects aligned to specific 21st century skills and clusters of 21st century skills. At 440, UDL is used to identify alternative learning experiences, such as development of assessments for student advancement, college readiness, career awareness, and workforce readiness. At 445, ECD is used to align the learning experiences developed in 435 and 440 by instituting, for example, an e-portfolio such as a project-based portfolio or journals for capturing relevant course activity.

FIG. 4, in short, illustrates how QMS 100 can be applied to develop PSLEDs for translating a course by:
Anchoring PSLEDs to targeted knowledge, skills, and abilities to create PSLEDs aligned to real life applications and workplace scenarios for students to progressively learn and practice 21st century skills;
‘Unpacking’ the Common Core Standards of Mathematics Practice (“CCSMP”) and Next Generation Science Standards (“NGSS”) to ‘tease out’ the big ideas and essential understandings of the IMEA course utilizing Understanding by Design;
Differentiating the curriculum, instruction and assessment within and across PSLEDs to establish problem-solving learning equity by Universal Design for Learning;
Aligning the relevant problem solving evidence over a range of knowledge, skills, attitudes and behavioral constructs into a coherent assessment framework utilizing Evidence Centered Design.

Using these techniques, the QMS can be used to develop different levels of classifications to scaffold the PSLED (and the elements within the PSLEDs) within a course (e.g., Algebra I), across courses (e.g., Algebra I, Physics), projects and workforce training, and align to standards. As a result, each PSLED and series of PSLEDs can have specific assessments that can lead to strategies for structured assessments covering a range of problem solving attributes. The robustness and flexibility of the QMS allows guiding constructs, such as for design process, to be mapped seamlessly against standards of learning and practice across course content or disciplines when creating the PSLEDs. Design can be a utilized as a process to apply content knowledge to solve problems from different disciplines, from math to science to the social sciences and the like. Design can also be used in the context of architecture or engineering or fashion and the like to bring concepts together across disciplines.

In addition, the QMS can be used for not only formative assessments, but also for summative problem- and scenario-solving skills within the context of technology-based platforms, such as the e-portfolio. As technologies create greater and more diverse opportunities to document, capture students learning and practice of problem solving, and problem-based learning, in general, QMS can provide a structured methodology to study students' trajectories of learning across problem-solving scenarios, mathematics, sciences and workforce domains.

In this second example, PSLED-based curriculum is discussed as well as examples of how such curriculum can be instructed and assessed. Utilizing concepts and principles embedded in, for example, engineering, the applied sciences, architecture, and fashion, in some embodiments, the QMS can develop and scaffold relevant, and real world energy and additive manufacturing problem solving activities into existing mathematics and science curriculum and other relevant disciplines, including the social sciences, economics, etc. QMS 100 can create blended, and flipped classroom learning environments based on standards with possible individual PSLEDs elements consisting of one or more of:
1. A three to eight minute online or video taped lecture by an expert the problem based scenario(s) along with other forms of electronic delivery such as iPads, smart phones, and projection devices, and hard copies media, such as DVDs and portable document format (PDF) or “PowerPoint” files;
2. An instructional guide for the teacher and/or instructor to create a flipped learning environment;
3. A guide to effectively engage mentors, peers, and other experienced practitioners in the student's efforts (the guide can incorporate prompts and suggestions at an interactive interface, such as an interface associated with inputs 250/outputs 260 of FIG. 2.
4. Curriculum maps to blend the units into specific mathematics and/or science lesson plans and/or scaffold across lesson plans/courses;
5. An experiential activity aligned to the key learning goals of each unit;
6. An online assessment guide aligned to each unit or series of units; and
7. A ‘text cert’ that aligns each unit to common text books for a particular course, such an Algebra I.

The units can be mapped to appropriate academic standards and workforce training, e. g., Common Core Standards of Mathematics Practice (“CCSMP”), Next Generation Science Standards (“NGSS”), and “Energy Career Clusters” as described by the Florida Department of Information. Initially, the topics for the problem-based scenarios can be focused on energy and additive manufacturing.

Middle and high school teachers, community college instructors and faculty, and university professors can be trained on the QMS to gain specific certification to create PSLEDs or a series PSLEDs for their grade level and courses, e.g., Algebra I or II, Pre-Calculus, Career Cluster for Energy Generation Technician or Automation and Production Technology. Parents, mentors, and peers can be trained to gain certification to assist with implementing or supporting PSLEDs or the QMS. Cost-effective professional development models (including PSLEDs specific for teacher and instructor training) can prepare the teachers and instructors through combinations of webinars, online courses and workshops. Professional development can be organized through partnerships with local institutions of higher education, such as local colleges, local school districts, or local training programs like union apprenticeships. Upon completion, instructors can be given online access to the PSLEDs and all elements (e.g. applying UDL to insure that the PSLEDs have the equity in variations to include different learning styles such as different cultural styles of learning, implementation at or within grade bands, etc.).

The QMS can be used to develop and outline taxonomies or hierarchical classification models to provide maps to scaffold the PSLEDs within a course (Algebra I) and across courses (e.g. Algebra I and II, Pre-calculus, Biology, and Career Clusters). Each PSLED and series of PSLEDs can have specific assessments aligned through ECD. The QMS can also be applied to embed a range of assessment instruments to capture a range of skills, competences, and proficiencies demonstrated by students within and across PSLEDs through the use of such tools as an e-portfolio as described above.

The use of the QMS to guide and implement principled assessments is a critical outcome, since the QMS system is applied by recognizing that problem solving is a creative, critical thinking, and collaborative activity involving not only procedural skills, but also cognitive, behavioral, and attitudinal constructs. In practice, problem solving is an iterative, critical thinking process often performed in dynamic settings. However, the use of PSLED blocks can add structure to dynamic settings without impeding the inherent flexibility of the setting.

The QMS fills a ‘gap’ since no current, unified model exists to study problem solving (and its range of attributes such as critical thinking and collaborative learning) through an principled assessment system that aligns the outputs of UbD and UDL through ECD to create and implement assessments to compare approaches to teach and practice problem solving across learning styles, domains of learning (e.g., academic and workforce), communities of learning (e.g., formal and informal), modalities of instruction (e.g., brick and mortar, online, blended, flipped), and effectiveness of mentors.

For example, the QMS can expand the dynamic range of assessments embedded in an e-portfolio database. Such assessments ranging from rubrics to score student work to instruments that track students' problem solving self-efficacy. Therefore, QMS has the potential to be used for not only formative assessments for each problem-solving scenario (PSLEDs), but also as a longitudinal record of student problem- and scenario-solving skills, and changes in problem solving attitudes over a series of PSLEDs. Assessment can be ongoing, cumulative, and real-time. For example, as information that has been tagged as an element that can provide assessment input for a student becomes available from the student, teacher, mentor, supervisor, instructor, etc., the assessment output can be modified or updated with each new information in real-time or at intervals. Thus creating opportunities to study student trajectories of learning for diagnostic assessment across scenarios, across mathematics and science concepts, across other content areas like social sciences, economics, fashion, architecture, etc., across professional areas, and across end of course, end of year, and end of learning cycle (e.g. pre-college and undergraduate) capstone projects. The QMS can guide the development and implementation of PSLEDs not only for the formal classroom environment and for online courses, but also for informal (e.g. after schools activities) such as student design competitions, tutoring programs (like “Sylvan Learning” or “Huntington Learning Centers”), homeschool, and homeschool hybrid courses.

Standards can not only be used as benchmarks for students or for assessment guidelines, but also the QMS can provide information as to the effectiveness of a standard to be “measured,” and to the extend it really tracks to the skills, knowledge, and abilities, intended to be tracked through the benchmarks and the intent (or learning objectives) of the standard.

A third example illustrates through the use of the concepts surrounding energy, how PSLEDs are aligned to academic and workforce training. As shown in FIG. 5, QMS can establish the ‘chain of reasoning’ to develop and align PSLED (e.g. curriculum, instructional and assessment) to a given ‘theme,’ such as Energy. Learning themes surrounding Energy can benefit from the application of QMS from the following perspectives:
The preparation of students to gain the fundamental ‘energy literacy’ skills and competencies to confidently succeed in an energy workplace being rapidly transformed by occupational and technology demands.
The implementation of energy (and sustainability) related PSLEDs through multiple instructional options—flipped classrooms, blended learning environments, traditional and online deliveries.
PSLEDs configured to cover a range of academic and occupational training opportunities for students—e.g. PSLEDs for convection, conduction and radiation aligned to mathematics and science courses and similar PSLEDs aligned to a Career Cluster for Energy.
Tailor specific PSLEDs utilizing UDL for ranges of learning communities—e.g. a rural community college utilizing an agricultural representation of the convection, conduction, and radiation PSLED.
Facilitate student mobility and credit transfer decisions through the use of equivalency maps between the various representations of a PSLED or series of PSLEDs.

QMS can map each PSLED element (e.g. video, instructional guide, experiential activity, text cert) to appropriate academic standards and workforce training guidelines, e.g., CCSMP, NGSS, and Energy Career Clusters. FIG. 5 illustrates how the QMS can create and align PSLEDs relating to Energy disciplines, in accordance with some embodiments. FIG. 5 also demonstrates how using PSLEDs can impact the development and testing of standards, especially in problem-solving, experiential situations. At 505, consistent with the flow diagram of FIG. 4, UbD is used to identify desired results. In this case, such results include the incorporation of Energy Literacy Standards and career and workforce readiness, and aligning 21st century skills. At 510, UDL is used to identify alternative skills and knowledge, including for example, options to provide alignment to high school standards, 21st century skills, and workforce competencies with considerations for equity of learning and multiple modes of expression (such as online and in-class content) for PSLEDs and clusters of PSLEDs related to energy. At 515, the standards and skills in 405 and 410 are aligned through ECD to produce, for example, energy related depth of understandings aligned to evidence and task models for 21st century skills. At 520, UbD is used to identify evidence of learning, including mapping required depth of understandings for individual 21st century skills related to energy through to specific task models. At 525, UDL is used to identify alternative forms of evidence, including curriculum based on community and institutional focus, including varying settings such as online and flipped classrooms. At 530, ECD aligns the results of 520 and 525 by providing, for example, specific assessments including quizzes, exams, surveys, discussions, presentations, National Training & Education Resource (“NTER”) activities, reports, portfolios, and e-portfolios.

At 535, UbD is used to identify learning experiences and instruction, such as creating classifications to map individual PSLEDs to one or more series of PSLEDs, to align project-based experiences across a course and courses, and to provide 21st century skills related to energy. At 540, UDL is used to identify alternative learning experiences, such as PSLED activities from 535 and associated 21st century activities that incorporate procedural, cognitive, attitudinal, and behavioral concepts. At 545, ECD is used to align the learning experiences developed in 535 and 540 by instituting, for example, e-portfolios, existing online libraries and resources, and assessments aligning different instructional settings (such as brick and mortar, apprenticeship, and online.

In practice, problem solving to prepare students (including active duty or transitioning veterans) for careers in energy and sustainability related fields require PSLEDs to be learned and practiced often in dynamic settings, problem solving setting representing real world and workforce issues. QMS fills a ‘gap’ since no current, unified model exists to present problem solving scenarios (PSLEDs) across the continuum of academic and career training processes required for individuals to transition from college to career readiness. QMS becomes a standard of practice to create, deliver, and assess PSLEDs within a theme, such as Energy.

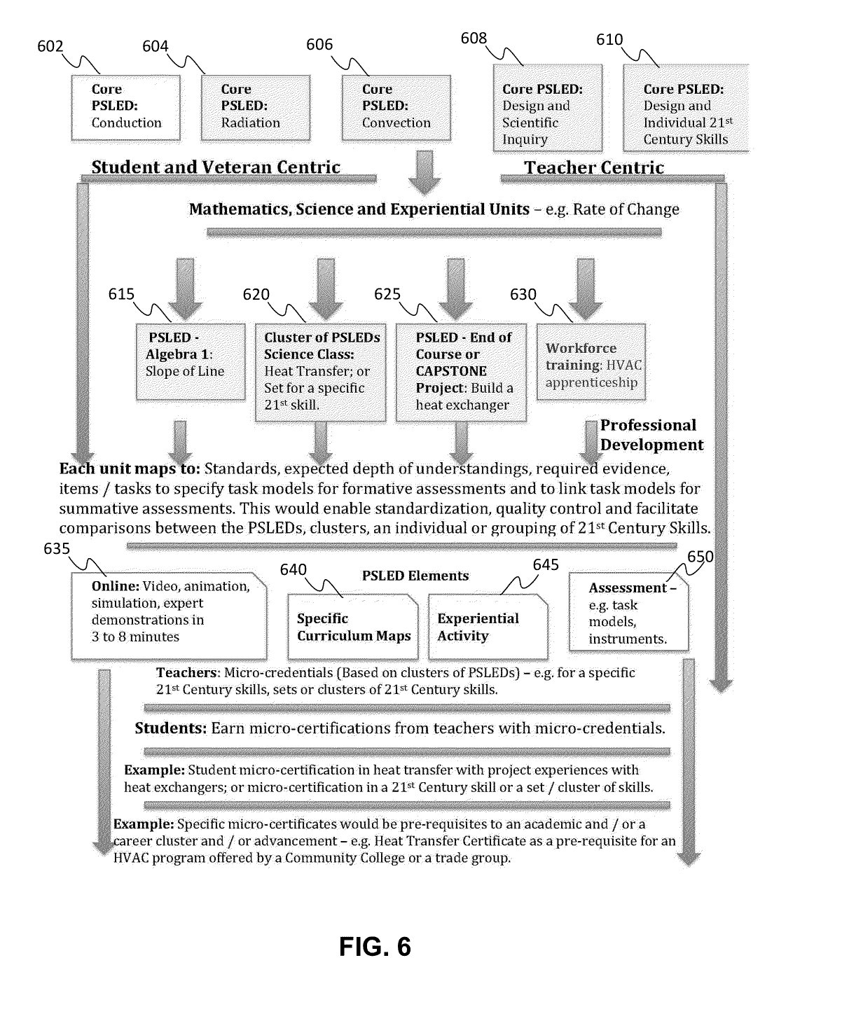

FIG. 6 illustrates how a structured, reproducible and ‘auditable’ QMS system, such as QMS 100, creates PSLEDs, in accordance with some embodiments. One skilled in the art will understand that this example is merely a representative sample that and can be altered and added upon to produce PSLEDs in other topics. Such PSLEDs produced can be both broadly utilized and compared in context of range of skills related to real world application in energy and sustainability. PSLEDs in FIG. 6 include student and active duty and transitioning veteran centric Core PSLEDs for conduction 602, radiation 604, and convection 606. They also include teacher centric PSLEDs for design and scientific inquiry 608 and design and individual 21st century skills 610. Expanding on PSLED 606 for convection, it turns out that this is a cluster of math, science, and experiential units PSLEDs. These can include a PSLED for Algebra l's topic of rate of change 615, another cluster of PSLEDs 620 in science for heat transfer and other 21st century skills, a PSLED 625 for an end of course capstone project to build a heat exchanger, and a PSLED 630 encapsulating workforce training through an HVAC apprenticeship.

Teacher centric PSLEDs 608 and 610 can incorporate PSLEDs designed to transfer knowledge, such as online video communication techniques 635 including video, animation, simulation, and expert demonstrations in relatively short fundamental concept lecture segments (such as covering logarithms) that may average three to eight minutes in length (or whatever length is appropriate or desired); specific curriculum maps 640; experiential activities 645; and assessment techniques 650, such as task models, instruments, and data mining. The Core PSLED for convection can identify a micro-certification that can be required as a pre-requisite for academic credit or career advancement.

As is illustrated, QMS is not only robust, but it is also a platform of interconnected models to establish the ‘chains of reasoning’ between depth of knowledge and the evidence I task models to assess an individual (and groups of individuals) to track trajectories of learning within and across the procedural, cognitive, behavioral, and attitudinal aspects of energy related, real world problem solving for both academic and career training pathways.

FIG. 7 illustrates a

As disclosed, embodiments implement a quality management system (“QMS”) for creating and managing PSLEDs. Creation of PSLEDs include analyzing and aligning course goals to 21st century skills. Managing PSLEDs include organizing PSLEDs into clusters of PSLEDs or courses, and awarding credentials or micro-credentials and certifications based on the completion of PSLEDs. Embodiments implement a database of PSLED for QMS, institutional, personal, or mentor tracking. Embodiments also provide an interface to PSLED content through course instruction techniques that can include lectures and problem solving. Managing PSLEDs also includes benchmarking, comparing, and assessing PSLEDs to evaluate their impact on their stated goals.

One of skill in the art will understand that, as used herein, teacher or instructor denote any person that present's PSLED content to a person learning the PSLED. Similarly, as used herein, student or practitioner denote a user of a PSLED for learning. In some embodiments, teachers can also be students. As used in this description, unless otherwise noted ‘or’ should be understood to be used inclusively. Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A system for managing course content for a course, comprising:
a database configured to store course content, the course content comprising a plurality of problem-solving learning environments and design (PSLED) blocks, wherein each PSLED block is based on at least one of curriculum, instruction, skills, and assessment information;
an interface configured to provide information from a PSLED block to a user and configured to receive assessment data for a student;
an input module configured to receive input regarding at least one of the PSLED blocks stored in the database;
an output module configured to send output regarding at least one of the PSLED blocks stored in the database;
an evaluation module configured to evaluate the student based on assessment requirements in at least one of the PSLED blocks stored in the database and based on the assessment data; and
a mapping module for analyzing and mapping attributes between PSLED blocks stored in the database, the attributes including at least one of equivalency of instructional units, equivalency of standards of learning and practice, equivalency of micro-certificates, and equivalency of micro-credentials.

2. The system of claim 1, wherein at least two PSLED blocks or elements are clustered and include an assessment module to quantify the student's 21st century skills, knowledge, and abilities relating to the completion of the cluster of PSLED blocks or elements.

3. The system of claim 1, wherein the database further stores PSLED information for the student, including PSLED blocks achieved.

4. The system of claim 3, wherein the system further comprises:
a transfer module for transferring achievements into a PSLED block based on information received by the input module, and based on the mapping module for aligning the equivalency of the achievements to PSLED blocks.

5. The system of claim 4, wherein the achievements correspond to PSLED blocks awarded by an external institution.

6. The system of claim 3, wherein the system further comprises:
an award module for awarding a certificate or credential based on a completion of PSLED blocks.

7. The system of claim 6, wherein the award module awards a certificate or credential by:
analyzing at least two certificates or credentials of the student;
determining PSLED blocks completed to achieve the certificates or credentials;
identifying a certificate or credential with PSLED block requirements that are satisfied by already completed PSLED blocks by the student; and
awarding a certificate or credential according to the PSLED blocks completed by the student based on the at least two certificates or credentials.

8. The system of claim 6, further comprising a suggestion module for suggesting PSLED blocks by:
analyzing completed PSLED blocks of the student;
identifying a certificate or credential with PSLED block requirements that overlap with completed PSLED blocks by the student; and
suggesting one or more PSLED blocks to complete to fulfill the certificate or credential.

9. The system of claim 1, wherein the student is at least one of a teacher, mentor, supervisor, instructor, parent, or PSLED organizer.

10. The system of claim 1, wherein the PSLED blocks include a flipped or informal learning environment.

11. The system of claim 1, wherein the system:
receives by the input module, from a facilitator, interaction information between facilitators related to a PSLED in progress by the student; and
stores the interaction information in the database.

12. The system of claim 2, wherein the clustered PSLED contains PSLED blocks from different originating institutions.

13. The system of claim 1, further comprising:
a remote computer that receives information from the output module, sends information to the input module, and a display that displays course content based on the interface information.

14. The system of claim 1, wherein the interface is configured based on configured preferences of the student and based on a learning level of the student.

15. The system of claim 3, further comprising a PSLED creation module for creating new PSLED blocks by:
analyzing stored PSLED blocks to identify skills; and
creating a new PSLED block by extracting skill related elements from a PSLED and combining them to create a new PSLED block.

16. The system of claim 1, further comprising a data mining module, the data mining module extracting and analyzing information based on PSLEDs completed or attempted by students or based on interactions between facilitators.

17. The system of claim 1, further comprising an award module configured to:
analyze prior work of the student, wherein the work originates from an external source;
compare the prior work to an equivalency for at least one PSLED; and
award a PSLED credit, cluster of PSLED credits, or PSLED-based credential or certificate, based on the prior work analysis.

18. The system of claim 3, further comprising a PSLED customization module for customizing a PSLED blocks by:
identifying a PSLED block for customization;
identifiying an accommodation including at least one of a learning style, student age, physical restriction, or different activity; and
creating a customized PSLED without altering the original PSLED by modifying the original PSLED with the accommodation.

19. The system of claim 3, further comprising:
a reporting module for receiving parameters for a customized report related to the student; and
generating a customized report related to the student for showing the student's achievements.

20. A system for creating a problem-solving learning environments and design (PSLED) block, comprising:
a database for PSLED block storage;
a PSLED creation module for:
creating a first PSLED element by applying Understanding by Design (UbD) principles to target skills, evidence, and learning environments;
creating a second PSLED based element on the first PSLED element by applying Universal Design by Learning (UDL) principles to expand targeted skills, evidence, and learning environments; and
creating a third PSLED element based on the first and second PSLED elements by applying Evidence Centered Design (ECD) principles by aligning and comparing the targeted and expanded skills, aligning and comparing the targeted evidence and expanded evidence, and aligning and comparing the targeted learning environments and expanded learning environments, wherein the aligning and comparing uses competency, evidence, and task models; and
creating a PSLED block based on at least one of the first, second, and third PSLED elements.

21. The system of claim 20, wherein at least two PSLED blocks or elements are clustered and include an assessment module to quantify a student's 21st century skills, knowledge, and abilities relating to the completion of the cluster of PSLED blocks or elements.

22. The system of claim 20, wherein the database further stores PSLED information for students, including PSLED blocks achieved.

23. The system of claim 22, wherein the achievements correspond to PSLED blocks awarded by an external institution.

24. The system of claim 22, wherein the system further comprises:
an award module for awarding a certificate or credential based on a completion of PSLED blocks.

25. The system of claim 24, wherein the award module awards a certificate or credential by:
analyzing one or more completed PSLED blocks of a student based on one or more awarded certificate or credential;
identifying a certificate or credential with PSLED block requirements that are satisfied by the user's already completed one or more PSLED block; and
awarding a certificate or credential according to the one or more PSLED block completed by the user based on the one or more awarded certificate or credential.

26. The system of claim 24, further comprising a suggestion module for suggesting PSLED blocks by:
analyzing completed PSLED blocks of the student;
identifying a certificate or credential with PSLED block requirements that overlap with completed PSLED blocks by the student; and
suggesting one or more PSLED blocks to complete to fulfill the certificate or credential.

27. The system of claim 22, wherein the user is at least one of a teacher, mentor, supervisor, instructor, parent, or PSLED organizer.

28. The system of claim 20, wherein the PSLED blocks include a flipped learning environment or informal learning environment.

29. The system of claim 20, wherein a clustered PSLED contains PSLED blocks from different originating institutions.

30. The system of claim 20, further comprising a PSLED creation module for creating new PSLED blocks by:
analyzing stored PSLED blocks to identify skills; and
creating a new PSLED block by extracting skill related elements from a PSLED and combining them to create a new PSLED block.

31. The system of claim 20, further comprising a data mining module, the data mining module extracting and analyzing information based on PSLEDs completed or attempted by students or based on interactions between facilitators.

32. The system of claim 20, further comprising an award module configured to:
analyze prior work of a student, wherein the work originates from an external source;
compare the prior work to an equivalency for at least one PSLED; and
award a PSLED credit, cluster of PSLED credits, or PSLED-based credential or certificate, based on the prior work analysis.

33. A system for delivering course content for an instructional course, comprising:
a database for storing problem-solving learning environments and design (PSLED) blocks;
a PSLED configuration module, configured to interrelate a PSLED to align to certificates and credentials pathways by linking the PSLED to multiple skills, linking skills to multiple subject areas, and linking subject areas to multiple certificates and multiple credentials;
a PSLED clustering module, configured to cluster PSLED blocks based on targeted skills, the clustering module selecting a PSLED from one subject matter area to cluster with a PSLED from another subject matter area, and the clustering module selecting PSLED blocks for implementing the targeted skills and PSLED blocks for evaluating student understanding; and
a course creation module, the course creation module:
creating a first course of instruction including a first and a second PSLED cluster; and
creating a second course of instruction including a third and the second PSLED cluster; and
an award module for awarding a certificate or credential to a student for successfully completing a PSLED cluster; and for awarding a certificate or credential to the student for successfully completing the first or second course of instruction.

34. The system of claim 33, wherein at least two PSLED elements are clustered and include an assessment module to quantify the user's 21st century skills, knowledge, and abilities relating to the completion of the cluster of PSLED elements.

35. The system of claim 33, wherein the database further stores PSLED information for students, including PSLED blocks achieved.

36. The system of claim 35, further comprising a suggestion module for suggesting PSLED blocks by:
analyzing completed PSLED blocks of the student;
identifying a certificate or credential with PSLED block requirements that overlap with completed PSLED blocks by the student; and
suggesting one or more PSLED blocks to complete to fulfill the certificate or credential.

37. The system of claim 33, wherein the user is at least one of a teacher, mentor, supervisor, instructor, parent, or PSLED organizer.

38. The system of claim 34, wherein the clustered PSLED contains PSLED blocks from different originating institutions.

39. The system of claim 35, further comprising a data mining module, the data mining module extracting and analyzing information based on PSLEDs completed or attempted by students or based on interactions between facilitators.

40. The system of claim 35, further comprising an award module configured to:
analyze prior work of the student, wherein the work originates from an external source;
compare the prior work to an equivalency for at least one PSLED; and
award a PSLED credit, cluster of PSLED credits, or PSLED-based credential or certificate, based on the prior work analysis.
